(19) United States
(12) Patent Application Publication
(10) Pub. No.: US 2026/0205707 A1
(43) Pub. Date: Jul. 16, 2026

(54) SYSTEM-ON-CHIP WITH COLOR GAMUT MAPPING CIRCUIT, METHOD OF OPERATING THE SAME, AND METHOD OF MAPPING COLOR GAMUT

(71) Applicant: Samsung Electronics Co., Ltd., Suwon-si (KR)

(72) Inventors: ILDO KIM, Suwon-si (KR); JOOHYUN LEE, Suwon-si (KR); JONGSEONG CHOI, Suwon-si (KR)

(21) Appl. No.: 19/445,956

(22) Filed: Jan. 12, 2026

(30) Foreign Application Priority Data
Jan. 13, 2025 (KR) 10-2025-0005028

(51) Int. Cl. H04N 23/84

(52) U.S. Cl. CPC H04N 23/841; H04N 23/843

(57) ABSTRACT

A system-on-chip includes a core processor configured to control an image sensor, an image signal processor configured to receive a raw image data from the image sensor and configured to process the raw image data, and a memory device configured to store a reference table including a conversion relationship between first pixel data of a first color gamut and second pixel data of a second color gamut, which are located in a three-dimensional color space. The image signal processor includes a color gamut mapping circuit configured to map a first image data located in the first color gamut to the second color gamut based on the reference table and configured to output a second image data located in the second color gamut, and the first image data is based on the raw image data.

### CROSS-REFERENCE TO RELATED APPLICATION(S)

This application claims priority to and the benefit of Korean Patent Application No. 10-2025-0005028, filed on January 13, 2025, in the Korean Intellectual Property Office, the disclosure of which is incorporated by reference herein in its entirety.

### BACKGROUND

An electronic device including a camera module employs various techniques to enhance the quality of images obtained from the camera module. For example, the electronic device adjusts the overall color balance of the obtained images using a color correction matrix.

An electronic device transmits image data to color-reproducing external devices, such as a display device or a printer. When an electronic device with a wide color gamut outputs image data to an external device with a narrow color gamut, the electronic device performs a color gamut mapping. That is, a conventional color gamut mapping is used to transmit image data from the electronic device with the wide color gamut to image output devices with the narrow color gamut.

### SUMMARY

Embodiments of the present disclosure described herein relate to an electronic device including a system-on-chip that performs a color gamut mapping using a color gamut mapping table and a generating device that generates the color gamut mapping table.

An object of the present disclosure is to enhance the quality of image data transmitted from a camera module. More specifically, an object of the present disclosure is to map color-corrected image data to a color gamut that is expressed with the same number of bit signals as original image data while maintaining the image quality of the color-corrected image data.

According to an embodiment, a method of mapping a color gamut includes allowing at least one processor to color-correct bit depth data corresponding to bit data that are representable in a three-dimensional first color gamut to generate color-corrected data, allowing the at least one processor to generate color-mapped data of a three-dimensional second color gamut based on the bit depth data and the color-corrected data, and allowing the at least one processor to quantize the color-mapped data to generate a three-dimensional reference table based on the quantized color-mapped data.

According to an embodiment, a system-on-chip includes a core processor controlling an image sensor, an image signal processor receiving raw image data from the image sensor and processing the raw image data, and a memory device storing a reference table including a conversion relationship between first pixel data of a first color gamut and second pixel data of a second color gamut, which are located in a three-dimensional color space. The image signal processor includes a color gamut mapping circuit mapping first image data located in the first color gamut to the second color gamut based on the reference table and outputting second image data located in the second color gamut, and the first image data are based on the raw image data. The first pixel data of the first color gamut and the second pixel data of the second color gamut may be located in a three-dimensional color space. The first image data may be based on the raw image data.The system-on-a-chipmay further comprise a core processor configured to control the image sensor.

According to an embodiment, a method of operating a system-on-chip includes allowing an image signal processor to receive first image data located in a first color gamut and demosaicing the first image data, allowing a color correcting circuit of the image signal processor to color-correct the demosaiced first image data to generate second image data located in a second color gamut, allowing a color mapping circuit of the image signal processor to map the second image data to the first color gamut based on a reference table to convert the second image data to third image data, and allowing the image signal processor to output the third image data located in the first color gamut.

According to the above, the quality of image data of the electronic device according to embodiments of the present disclosure is improved.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device according to an embodiment of the present disclosure;

FIG. 2 is a block diagram illustrating an image system including a reference table generating device and an electronic device according to an embodiment of the present disclosure;

FIGS. 3 and 4 are views illustrating a color correction method of a related art;

FIGS. 5 and 6 are views conceptually illustrating a method of generating a reference table for a color gamut mapping according to an embodiment of the present disclosure;

FIG. 7 is a view illustrating color gamuts according to an embodiment of the present disclosure;

FIG. 8 is a flowchart illustrating a method of a color gamut mapping according to an embodiment of the present disclosure;

FIG. 9 is a block diagram illustrating a reference table generating device according to an embodiment of the present disclosure;

FIG. 10 is a block diagram illustrating a reference table generator of a reference table generating device according to an embodiment of the present disclosure;

FIG. 11 is a block diagram illustrating a color gamut adjusting module according to an embodiment of the present disclosure;

FIG. 12 is a view illustrating an operation of a constant axis mapping module according to an embodiment of the present disclosure;

FIG. 13 is a view illustrating an operation of an adaptive mixing module according to an embodiment of the present disclosure;

FIGS. 14 and 15 are views illustrating an operation of a quantizing module according to an embodiment of the present disclosure;

FIG. 16 is a flowchart illustrating an operation of an electronic device performing a color gamut mapping of image data according to an embodiment of the present disclosure;

FIG. 17 is a block diagram illustrating an image signal processor of an electronic device according to an embodiment of the present disclosure;

FIG. 18 is a block diagram illustrating a color gamut mapping circuit of an image signal processor according to an embodiment of the present disclosure;

FIG. 19 is a view illustrating an operation of a block region selection circuit according to an embodiment of the present disclosure;

FIG. 20 is a view illustrating an operation of an interpolation circuit according to an embodiment of the present disclosure;

FIG. 21 is a block diagram illustrating an image signal processor according to an embodiment of the present disclosure; and

FIG. 22 is a view illustrating a color gamut mapping method for a video of an electronic device according to an embodiment of the present disclosure.

### DETAILED DESCRIPTION

Below, embodiments of the present disclosure will be described in detail and clearly to such an extent that an ordinary one in the art easily implements the disclosure.

As is traditional in the field of the disclosed technology, features and embodiments are described, and illustrated in the drawings, in terms of functional blocks, units, and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the embodiments may be physically separated into two or more interacting and discrete blocks, units, and/or modules without departing from the scope of the inventive concepts. Further, the blocks, units, and/or modules of the embodiments may be physically combined into more complex blocks, units, and/or modules without departing from the scope of the inventive concepts.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

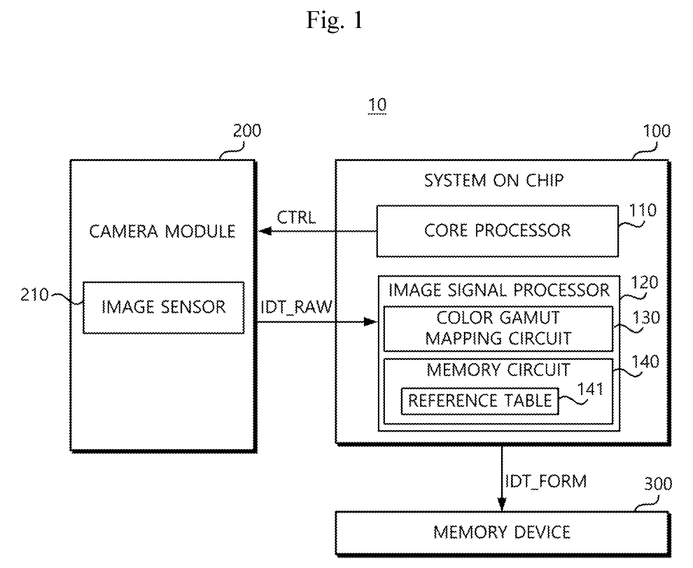

FIG. 1 is a block diagram illustrating an electronic device 10 according to an embodiment of the present disclosure.

The electronic device 10 may include a system-on-chip 100 and a camera module or camera circuit 200. The electronic device 10 may be a device including a camera device and receiving image data from the camera device. The electronic device 10 may be a mobile device. As an example, the electronic device 10 may be a smartphone, a computer, a laptop, a tablet computer, a personal digital assistant (PDA), a smart glasses, a desktop computer, etc. The electronic device 10 should not be limited to any particular type.

A core processor 110 of the system-on-chip 100 may transmit a control signal CTRL to the camera module 200 to control the camera module 200. The core processor 110 may control an overall operation of the electronic device 10 as well as the camera module 200. As an example, the core processor 110 may control a display device and a user interface of the electronic device 10. The core processor 110 may perform various operations for the operation of the electronic device 10 based on instructions loaded in a memory device 300. As an example, the system-on-chip 100 may be an application processor of the mobile device.

The camera module 200 may include an image sensor 210. As an example, the image sensor 210 may be a complementary metal oxide semiconductor (CMOS) image sensor. The image sensor should not be limited to any particular type.

In an embodiment, the image sensor 210 of the camera module 200 may include a pixel array in which different color filters are repeatedly arranged. As an example, the color filters may be arranged in a Bayer pattern. The pattern of the color filters should not be particularly limited.

In an embodiment, the camera module 200 may transmit raw image data IDT_RAW based on the color filters to the system-on-chip 100.

An image signal processor 120 of the system-on-chip 100 may receive the raw image data IDT_RAW from the camera module 200.

When the image signal processor 120 receives the raw image data IDT_RAW based on the color filters from the camera module 200, the image signal processor 120 of the system-on-chip 100 may perform demosaicing on the raw image data IDT_RAW.

The image signal processor 120 may perform image processing on the demosaiced raw image data IDT_RAW and then convert the image-processed raw image data IDT_RAW into image data IDT_FORM that conform to an image format. As an example, the image signal processor 120 may convert the image-processed raw image data IDT_RAW into the image data IDT_FORM conforming to JPEG (Joint Photographic Experts Group) image format, and the image format should not be particularly limited. The image signal processor 120 may store the image data IDT_FORM conforming to the image format into the memory device 300.

The memory device 300 may be a volatile memory device or a non-volatile memory device. As an example, the memory device 300 may include a dynamic random access memory (DRAM), a static random access memory (SRAM), a flash memory, a phase-change random access memory (PRAM), a magnetic random access memory (MRAM), or a resistive random access memory (RRAM).

The image signal processor 120 of the system-on-chip 100 according to the present embodiment may convert first image data located in a first color gamut into second image data located in a second color gamut during the image processing. As an example, the image signal processor 120 may include a color gamut mapping circuit 130 that maps the first image data located in the first color gamut to the second color gamut based on a reference table 141.

A color gamut may be a region that defines the range of colors reproducible by a device within a color space represented by a plurality of color axes.

In the present disclosure, the first color gamut and the second color gamut may be different color gamuts from each other. As an example, a size of the space defined by the first color gamut may differ from that defined by the second color gamut. For example, the first color gamut may include the second color gamut.

The reference table 141 may be temporarily stored in a memory circuit 140 of the image signal processor 120. According to an embodiment, the reference table 141 may be stored in the memory device 300, and the image signal processor 120 may refer to the reference table 141 stored in the memory device 300.

In a case where the image-processed first image data is located in the first color gamut outside the second color gamut, the color gamut mapping circuit 130 of the image signal processor 120 may map the first image data to the second color gamut. The second color gamut may not be a region defined by the image format. According to an embodiment, the second color gamut may be a color gamut that is outside the settings or range of the image data to be stored. For example, the color gamut mapping circuit 130 may not clip the first image data outside the second color gamut and may map the first image data to the second color gamut, and thus, improved quality of the image-processed first image data may be maintained.

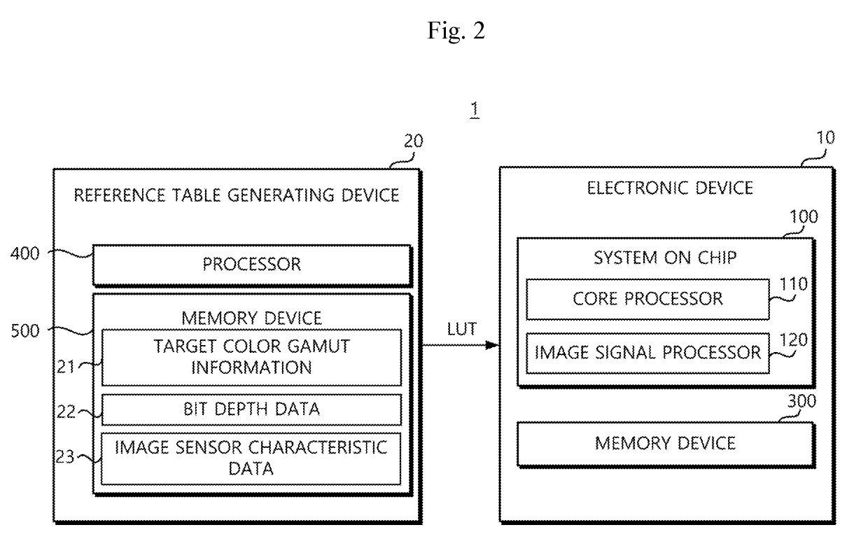

FIG. 2 is a block diagram illustrating an image system 1 including the electronic device 10 and a reference table generating device 20 according to an embodiment of the present disclosure. The electronic device 10 described with reference to FIG. 2 may correspond to the electronic device 10 of FIG. 1. Detailed explanations that are identical or similar to those described with reference to FIG. 1 will be omitted. Hereinafter, the electronic device 10 and the reference table generating device 20 will be described with reference to FIGS. 1 and 2.

The reference table generating device 20 may generate a reference table (LUT) used in mapping of the color gamut and may transmit the generated reference table LUT to the electronic device 10 either online or offline.

The reference table generating device 20 may include a processor 400 and a memory device 500. The reference table generating device 20 may further include configurations of a typical computing device. For example, the reference table generating device 20 may include a storage device, such as a hard disk drive (HDD) and a solid-state drive (SSD), and a network interface device. The reference table generating device 20 may be a server, however, it should not be particularly limited.

The reference table generating device 20 may generate the reference table LUT based on target color gamut information 21, bit depth data 22, and image sensor characteristic data 23. The reference table LUT may correspond to the reference table 141 of FIG. 1.

The target color gamut information 21, the bit depth data 22, and the image sensor characteristic data 23 may be loaded to the memory device 500 from the storage devices.

In an embodiment, the target color gamut information 21 may include information specifying the color gamut of a destination to which colors are to be mapped. As an example, when the first image data of the first color gamut is mapped to the second color gamut, the target color gamut information 21 may include information specifying the second color gamut.

In an embodiment, the target color gamut information 21 may include information specifying a color gamut based on the image format. As an example, the target color gamut information 21 may be one of CIE 1931 (XYZ), sRGB, scRGB, DCI-P3, BT. 2020, BT. 2100, and ACES, but it should not be particularly limited.

In an embodiment, the bit depth data 22 may be bit data representing a color gamut of a source in which the colors to be mapped are expressed. As an example, in a case where the first image data of the first color gamut is mapped to the second color gamut and the first image data includes five bit signals, the bit depth data 22 may include bit signals in the range of ‘00000’ to ‘11111’.

In an embodiment, the image sensor characteristic data 23 may include information describing characteristic of the image sensor that provides the image data to be mapped. As an example, in a case where the first image data of the first color gamut is mapped to the second color gamut and the first image data is generated from a specific image sensor, the image sensor characteristic data 23 may include information describing characteristic of the specific image sensor. For example, the information describing the characteristic of the specific image sensor may include parameters related to the physical configuration of the image sensor, such as Quantum Efficiency (QE), spectral response, dynamic range, noise characteristic, channel gain, and white balance as well as parameters related to the characteristic of the image data generated by the image sensor.

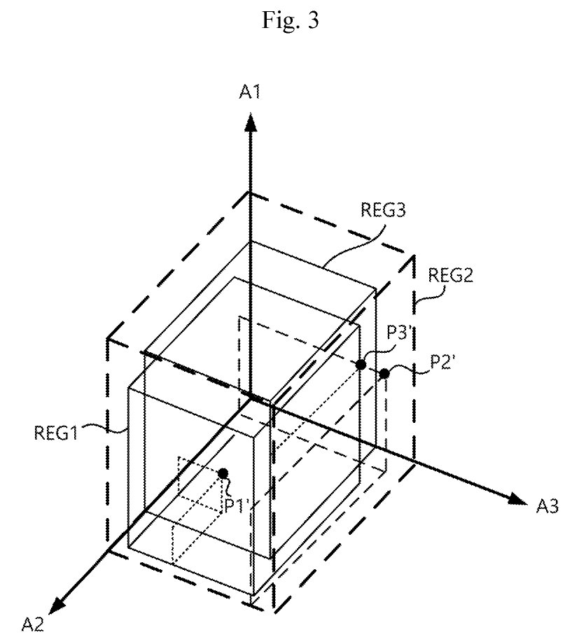

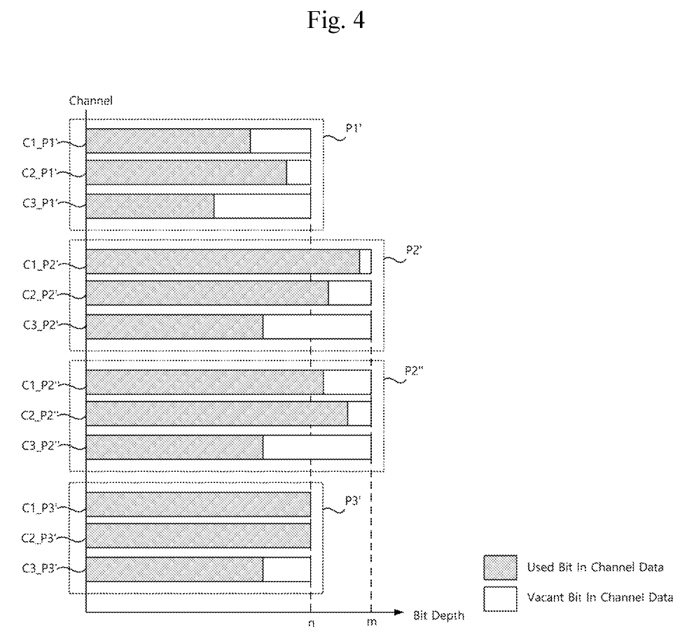

FIGS. 3 and 4 are views illustrating a color correction method of a related art.

FIG. 3 illustrates a first color gamut REG1, a second color gamut REG2, and a third color gamut REG3 of a color space defined by color axes A1, A2, and A3. FIG. 3 illustrates a pixel P1’ of image data located in the first color gamut REG1, a pixel P2’ of image data located in the second color gamut REG2, and a pixel P3’ of image data located in the third color gamut REG3. FIG. 4 illustrates a configuration of bit signals for each channel of each of the pixels P1’, P2’, and P3’ of FIG. 3.

The first pixel P1’ is a pixel of first image data, and the second pixel P2’ is a pixel of second image data generated while image processing is being applied to the first image data. The third pixel P3’ is a pixel of the second image data generated after completing the image processing of the first image data.

An electronic device according to the related art generates the second image data by performing the image processing, such as the color correction, on the first image data.

Referring to FIG. 3, the second pixel P2’ of the second image data, generated while image processing is being applied to the first image data, is located in the second color gamut REG2 outside the first color gamut REG1. The electronic device according to the related art stores the image-processed image data as the image data of the third color gamut REG3. Accordingly, the electronic device according to the related art clips the second pixel P2’ of the second image data generated during the image processing to convert the second pixel P2’ to the third pixel P3’ of the third color gamut REG3. The third color gamut REG3 is located in the second color gamut REG2. Depending on context, the term “pixel”, such as in “first pixel P1” and other contexts may refer to data associated with or from the pixel rather than referring to the pixel as a sensor element.

Referring to FIG. 4, each of the pixels P1’, P2’, and P3’ of FIG. 3 includes a plurality of bit signals for each channel. The electronic device according to the related art represents the image data of the first color gamut REG1 of FIG. 3 using n-bit signals and represents the image data of the second color gamut REG2 using m-bit signals (m>n).

The bit signals C1_P1’, C2_P1’, and C3_P1’ for each channel (e.g., respectively for the first channel C1, second channel C2, and third channel C3) of the first pixel P1’ may include data in some or a portion of the n-bit signals (a hatched region) and may not include data in the remaining portion of bit signals of the n-bit signals (a blank region). For example, to store information, some bit signals such as the bit signal C1_P1’ may use only k-bit(k is smaller than n) among the n-bit allocated. . In one example, when “4 bits” are allocated to represent the pixels of the first image data, each pixel may have a value ranging from ‘0000’ to ‘1111’. For instance, in some cases, a pixel may be represented as ‘0001’. The relevant portion refers to this case.

Among the bit signals C1_P2’, C2_P2’, and C3_P2’ for each channel of the second pixel P2’ generated by image-processing the first pixel P1’, a first channel bit signal C1_P2’ and a second channel bit signal C2_P2’ may include data in more than n-bit signals.

To store the image-processed image data as the second image data of the third color gamut REG3, the electronic device according to the related art clips portions of n-bit signals exceeding n bits in the first channel bit signal C1_P2’ and the second channel bit signal C2_P2’ to generate the bit signals C1_P3’, C2_P3’, and C3_P3’ for each channel of the third pixel P3’ and stores the clipped bit signals for each channel in storage devices.

Accordingly, the electronic device according to the related art clips at least a portion of the image-processed image data even after the image processing such as the color correction. For example, the second image data from which a portion of the image-processed information is removed are stored. Therefore, the quality of image processing is deteriorated.

In addition, the electronic device according to the related art distorts the relationship between the information for each channel of the image data by uniformly clipping at least a portion of the image-processed image data in a manner that moves at least the portion of the image-processed image data to a surface of the third color gamut REG3.

As an example, referring to FIG. 4, both the pixels P2’ and P2’’, which include different information and are located within the second color gamut REG2, are clipped to the same pixel P3’ of the third color gamut REG3. For example, although portions of the information for each channel of each of the image-processed pixels P2’ and P2’’ have different sizes, the portions of the information are changed to have the same size due to the clipping, resulting in the loss of such size relationships. As a result, the relationship between the information for each channel is distorted. Accordingly, pixels having different colors before the color correction result in having the same color after the color correction.

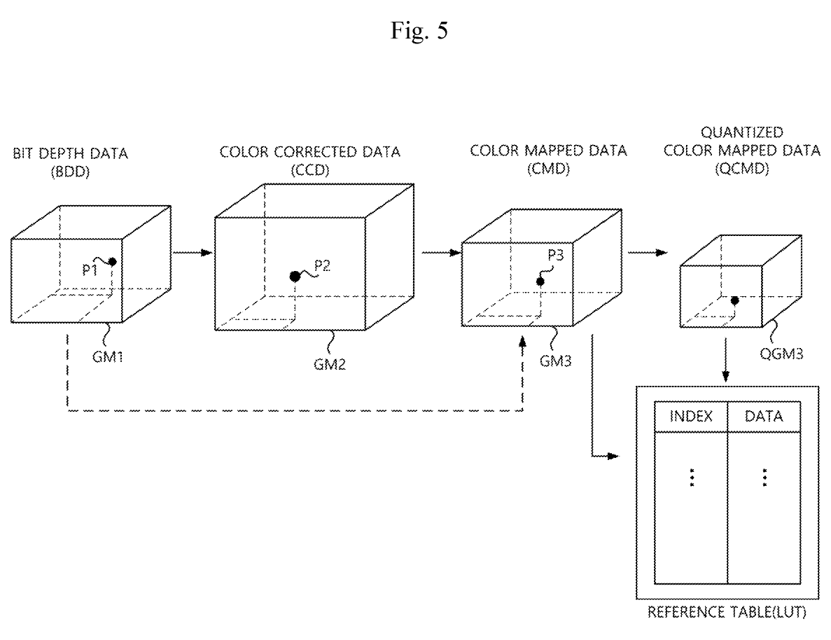

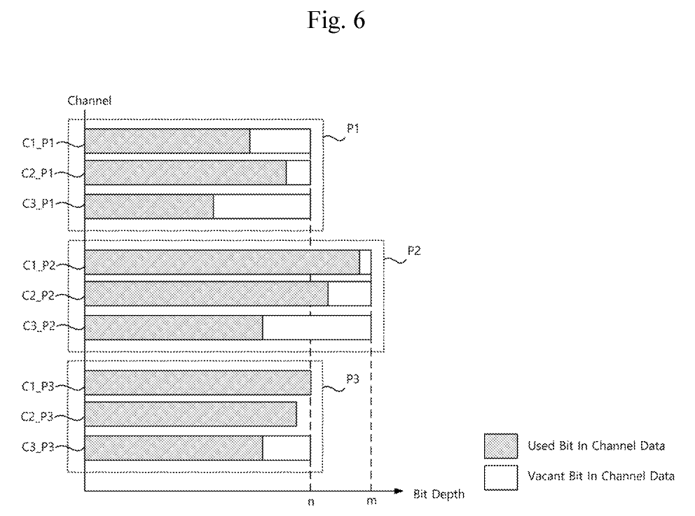

FIGS. 5 and 6 are views conceptually illustrating a method of generating the reference table for the color gamut mapping according to an embodiment of the present disclosure. The method of generating the reference table according to the embodiment of FIGS. 5 and 6 may be performed by the reference table generating device 20 shown in FIG. 2. Hereinafter, the method of generating the reference table by the reference table generating device 20 will be described with reference to FIGS. 2, 5, and 6.

FIG. 5 illustrates the first color gamut GM1, the second color gamut GM2, and the third color gamut GM3 as a hexahedral region, however, the color gamut according to the present disclosure should not be limited to the hexahedral region and may be a region with various shapes. As an example, the shape of the color gamut should not be particularly limited and may take shapes such as a cone, an ellipse, or others. The second color gamut GM2 and the third color gamut GM3 described with reference to FIG. 5 may correspond to the first color gamut and the second color gamut described with reference to FIG. 1, respectively.

Referring to FIG. 5, the reference table generating device 20 may generate bit depth data BDD representing the first color gamut GM1. The first color gamut GM1 may be the color gamut based on the target color gamut information of FIG. 2.

The bit depth data BDD may be bit data representing the first color gamut GM1. As an example, when the first image data of the first color gamut GM1 include n-bit signals, the bit depth data BDD may include pixels located in the first color gamut GM1 among a plurality of pixels that may be expressed by n-bit signals (for example, image data expressed by bit signals from "000…00" where all bits of an n-bit signal are or have the value of “0” to "111.. 11" where all bits of an n-bit signal are or have the value of “1”). A first pixel P1 may be a pixel expressed by any one bit depth data among a plurality of bit depth data BDDs located in the first color gamut GM1.

In an embodiment, the bit depth data BDD may include a plurality of bit signals for each channel. As an example, the bit depth data BDD may include three bit signals for each channel. The bit signal for each channel may have n-bits or be an n-bit signal.

The reference table generating device 20 may convert the bit depth data BDD of the first color gamut GM1 using a color correction matrix.

As an example, when each of the bit depth data BDD includes three bit signals for each channel and each bit signal for each channel is an n-bit signal, a 3×3 color correction matrix may be applied to the three bit signals for each channel of the bit depth data BDD to generate color-corrected data CCD. In this case, some pixels of the color-corrected data CCD may be located in the second color gamut GM2. As an example, a second pixel P2 may be a pixel represented by any one color-corrected data CCD among a plurality of color-corrected data CCDs located in the second color gamut GM2. The second pixel P2 may be present outside the first color gamut GM1 and inside the second color gamut GM2. The second color gamut GM2 may be larger than the first color gamut GM1.

The reference table generating device 20 may generate the color correction matrix based on the image sensor characteristic data. Various well-known techniques may be used to generate the color correction matrix based on the image sensor characteristic data.

The reference table generating device 20 may map the color-corrected data CCD located in the second color gamut GM2 to the third color gamut GM3. As an example, a third pixel P3 may be a pixel obtained by mapping the second pixel P2, which is located outside the third color gamut GM3 and inside the second color gamut GM2, to the third color gamut GM3. The third color gamut GM3 may be a color gamut different from the first color gamut GM1. The first color gamut GM1 and the third color gamut GM3 may be color gamuts that may be expressed with the same number of bit signals.

In an embodiment, the reference table generating device 20 may map the color-corrected data CCD located in the second color gamut GM2 to the third color gamut GM3 by taking into account the bit depth data BDD and the color-corrected data CCD. The reference table generating device 20 may consider the pixels of the bit depth data BDD before each pixel of the color-corrected data CCD is color-corrected, in determining the pixel to which each pixel of the color-corrected data CCD is to be mapped.

In an embodiment, interpolation may be carried out by assigning respective weights to each of the color-corrected data CCD and the bit depth data BDD corresponding to the color-corrected data CCD. As an example, an interpolated value, which is obtained by assigning respective weights to at least one channel signal of the color-corrected data CCD and at least one channel signal of the bit depth data (BDD) corresponding to the color-corrected data CCD, may be used to generate at least one channel signal of color-mapped data CMD. For example, image data, depending on the context, may include or be made up of one or more channel signals.

In an embodiment, the weights may be determined based on a distance between the color-corrected data CCD and the third color gamut GM3. As an example, a greater weight may be applied to the bit depth data BDD as the distance between the color-corrected data CCD and the third color gamut GM3 increases.

Accordingly, the color-corrected data CCD located in the second color gamut GM2 may not need to be simply clipped to the surface of the third color gamut GM3. The reference table generating device 20 may determine the color-mapped data CMD by taking into account the bit depth data BDD prior to color correction. As a result, each of the channel signals constituting the image data may be prevented from being distorted. In addition, the quality of the image processing (e.g., the color correction) may be maintained.

FIG. 6 illustrates a plurality of bit signals for each channel of each of pixels P1, P2, and P3 of FIG. 5. The image data of the first color gamut GM1 and the third color gamut GM3 of FIG. 6 may be represented with n-bit signals, and the image data of the second color gamut GM2 of FIG. 6 may be represented with m-bit signals (m>n).

Referring to FIG. 6, among bit signals C1_P2, C2_P2, and C3_P2 for each channel of the color-corrected data CCD, a first channel bit signal C1_P2 and a second channel bit signal C2_P2 may each include data that exceeds a range representable by an n-bit signal, such as an n-bit signal corresponding to the first color gamut GM1 and the third color gamut GM3. Further, the first channel bit signal C1_P3 and the second channel bit signal C2_P3 of the color-mapped data CMD may have values different from each other; so they do not have the same value. In addition, for example, the relationship between information for each channel of the color-corrected data CCD may be maintained in the color-mapped data CMD without distortion. Accordingly, the quality of the image processing may be improved. The quality of the image processing may not be deteriorated.

Referring to FIG. 5 again, the reference table generating device 20 may generate the reference table LUT based on the color-mapped data CMD. As an example, the reference table generating device 20 may configure the data of the reference table LUT using the color-mapped data CMD.

In an embodiment, the reference table generating device 20 may quantize the color-mapped data and may generate the reference table LUT based on the quantized color-mapped data QCMD.

The reference table generating device 20 may configure the data of the reference table LUT using pixels of the quantized color-mapped data QCMD.

In an embodiment, the reference table generating device 20 may configure, e.g., construct, build, or generate, an index of the reference table LUT using or based on pixels of one of the bit depth data BDD and the color-corrected data CCD.

As an example, when the index of the reference table LUT is configured or generated using the pixels of the color-corrected data CCD, the electronic device 10 of FIG. 1 may use the reference table LUT to map the image-processed raw image data IDT_RAW to a color gamut that is representable by the same number of bit signals as the color gamut of the raw image data IDT_RAW.

As an example, when the index of the reference table LUT is configured or generated using the pixels of the bit depth data BDD, the electronic device 10 of FIG. 1 may use the reference table LUT to perform the image processing (for example, color correction processing) and the raw color mapping of the raw image data IDT_RAW simultaneously. The color mapping may refer to mapping the image-processed raw image data IDT_RAW to a color gamut that may be represented with the same number of bit signals as that of the raw image data IDT_RAW.

In the embodiment of FIGS. 5 and 6, the color correction is described as a representative example, however, the image processing of the present disclosure may be applied to processes other than the color correction. As an example, when the image processing causes the original image data to exceed its original color gamut, the reference table generating device 20 may generate the reference table LUT to perform the color gamut mapping using the method illustrated in FIGS. 5 and 6.

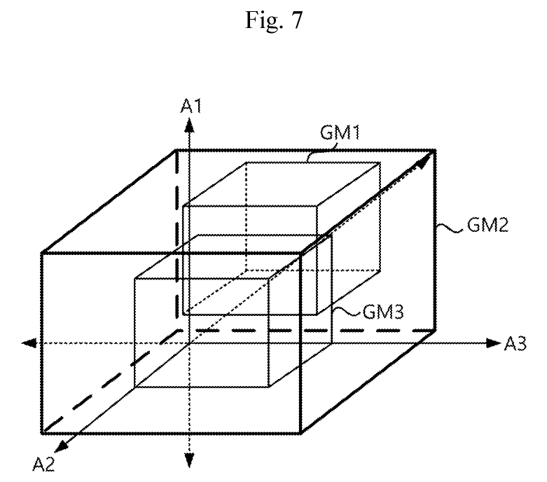

FIG. 7 is a view illustrating color gamuts GM1, GM2, and GM3 according to an embodiment of the present disclosure. The color gamuts GM1, GM2, and GM3 of FIG. 7 may correspond to the color gamuts GM1, GM2, and GM3 of FIG. 5.

The first color gamut GM1 may be the color gamut before the image processing is performed, and the second color gamut GM2 may be the color gamut after the image processing is performed. The third color gamut GM3 may be the color gamut to which the image-processed image data is mapped. The first color gamut GM1 and the third color gamut GM3 may be color gamuts that may be expressed with the same number of bit signals.

The electronic device 10 of FIG. 1 may store the image data of the third color gamut GM3. Accordingly, the electronic device 10 may map the image-processed image data to the third color gamut GM3 using the reference table LUT generated by the method of FIGS. 5 and 6 and then may store the image-processed image data.

The first color gamut GM1 and the third color gamut GM3 may be a region in which all the image data have a positive value with respect to the color axes A1, A2, and A3 of the color space.

The second color gamut GM2 may include an area in which at least a portion of the channel signals of the image data has a negative value with respect to the color axes A1, A2, and A3 of the color space. As an example, a portion of the channel signals of any one pixel of the image-processed image data may have a negative value. Referring to FIG. 7, the second color gamut GM2 may extend to an area with the negative value in directions toward a second color axis A2 and a third color axis A3.

Accordingly, even when the image-processed image data is located in the second color gamut GM2 having the negative value, the electronic device according to the present disclosure may map the image-processed image data to the third color gamut GM3 having the positive value using the reference table generated by the reference table generating device and then may store the mapped image data. Therefore, the electronic device may perform the image processing reliably regardless of the outcome of the image processing. In addition, the quality of the image processing may be ensured.

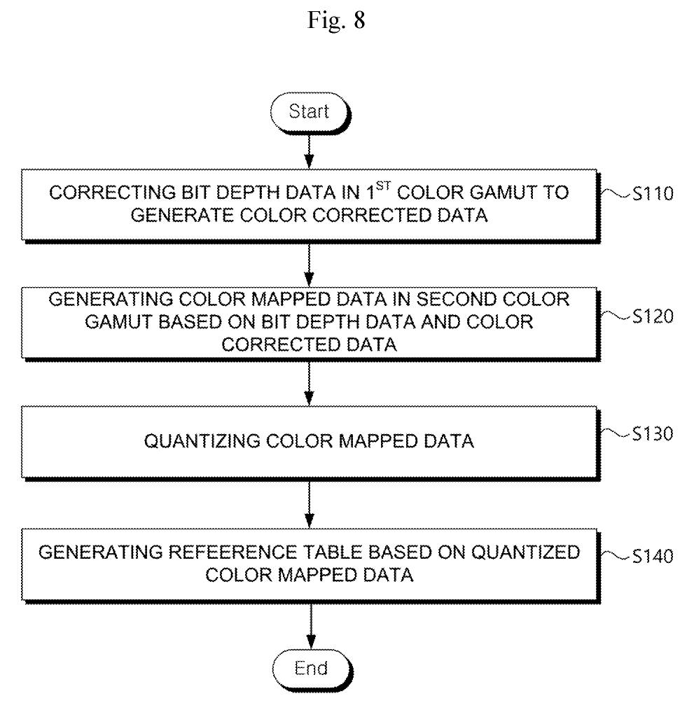

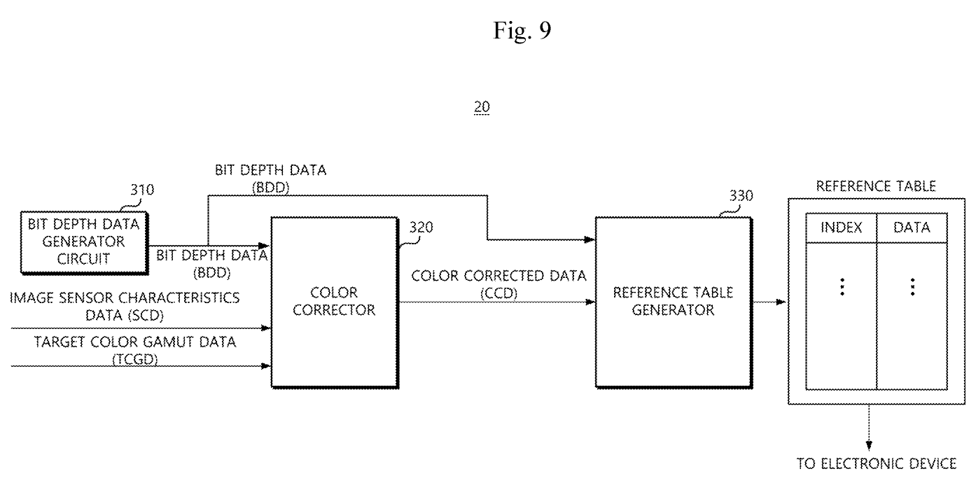

FIG. 8 is a flowchart illustrating a method of a color gamut mapping according to an embodiment of the present disclosure. FIG. 9 is a block diagram illustrating a reference table generating device 20 according to an embodiment of the present disclosure. The color gamut mapping method of FIG. 8 may be performed by the reference table generating device 20 of FIG. 2. Detailed explanations that are identical or similar to those described with reference to FIGS. 1 to 7 will be omitted. Hereinafter, the color gamut mapping method of the reference table generating device 20 will be described with reference to FIGS. 8 and 9.

Referring to FIG. 8, in operation S110, at least one processor of the reference table generating device 20 of FIG. 2 may perform the color correction on the bit depth data corresponding to the bit data representable in a three-dimensional first color gamut to generate the color-corrected data.

Referring to FIG. 9, a bit depth data generator circuit 310 may generate the bit depth data BDD and may transmit the bit depth data BDD to a color corrector circuit 320. The bit depth data BDD may correspond to the bit depth data BDD of FIG. 5. The bit depth data BDD may be located in the first color gamut GM1 of FIG. 5. The bit depth data BDD may correspond to the bit data representable in the first color gamut GM1. As an example, the bit depth data BDD may include pixels located in the first color gamut GM1 among the pixels representable by the n-bit signals. In an embodiment, the pixels may be located in a three-dimensional color space of the first color gamut GM1.

The color corrector circuit 320 may generate the color correction matrix with reference to the image sensor characteristic data SCD and target color gamut data TCGD. The color corrector circuit 320 may apply the color correction matrix to the bit depth data BDD to generate the color-corrected data CCD. The color-corrected data CCD may correspond to the color-corrected data CCD of FIG. 5.

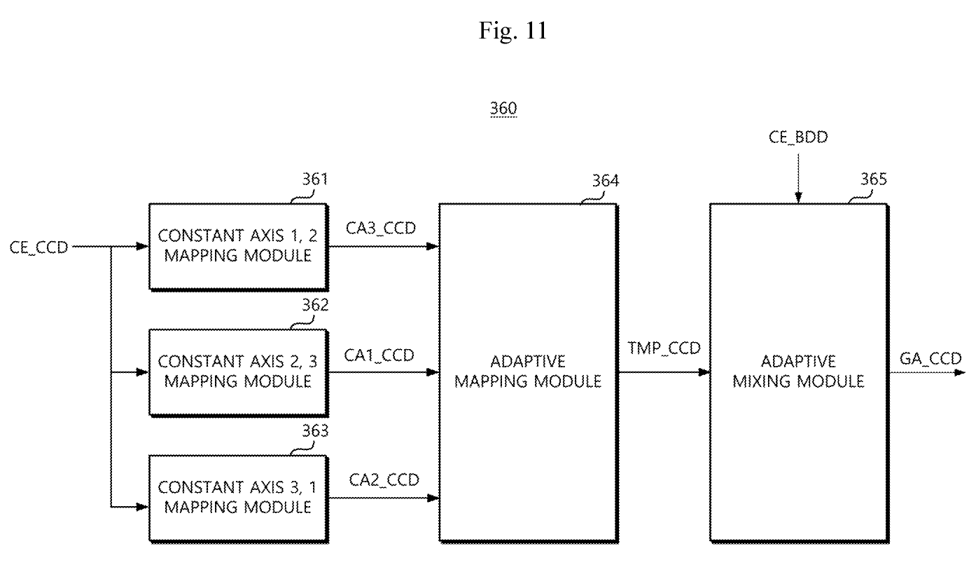

Referring to FIG. 8 again, in operation S120, a reference table generator circuit 330 of FIG. 9 may generate the color-mapped data based on the bit depth data BDD and the color-corrected data CCD. The color-mapped data may be located in the second color gamut GM2 of FIG. 5. This will be described below in detail with reference to FIGS. 11 to 13.

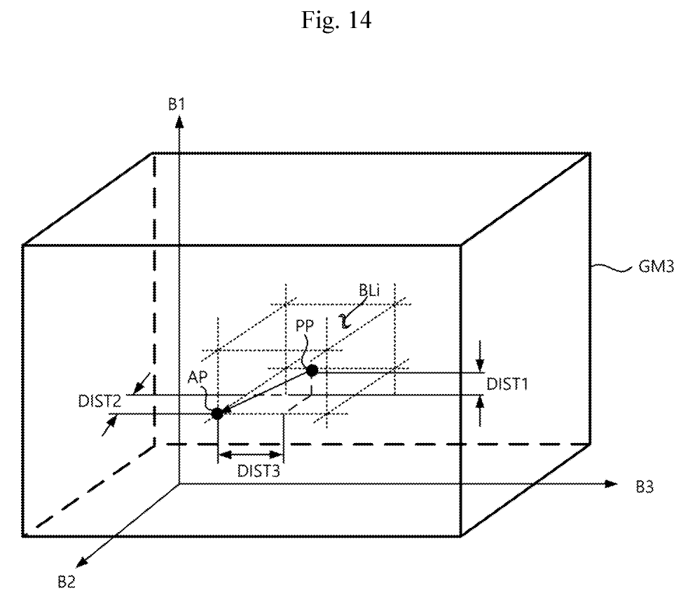

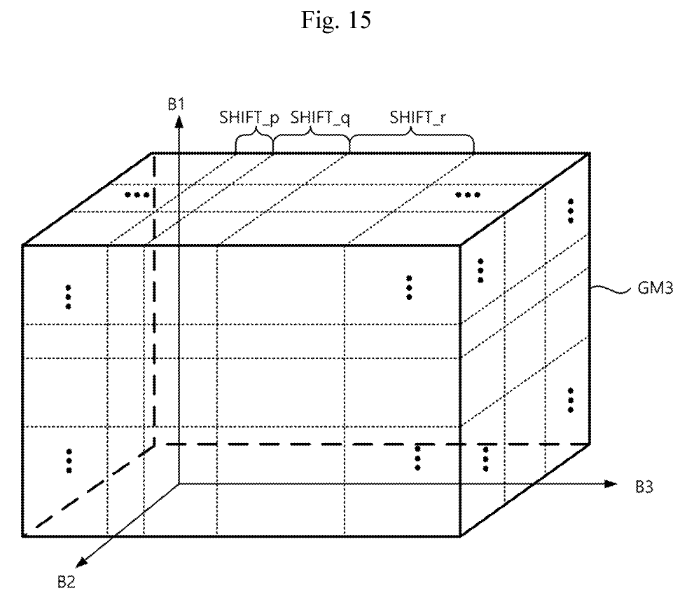

In operation S130, the reference table generator circuit 330 of FIG. 9 may quantize the color-mapped data and may generate a three-dimensional reference table based on the quantized color-mapped data. The reference table may correspond to the reference table LUT of FIG. 5. This will be described below in detail with reference to FIGS. 14 and 15.

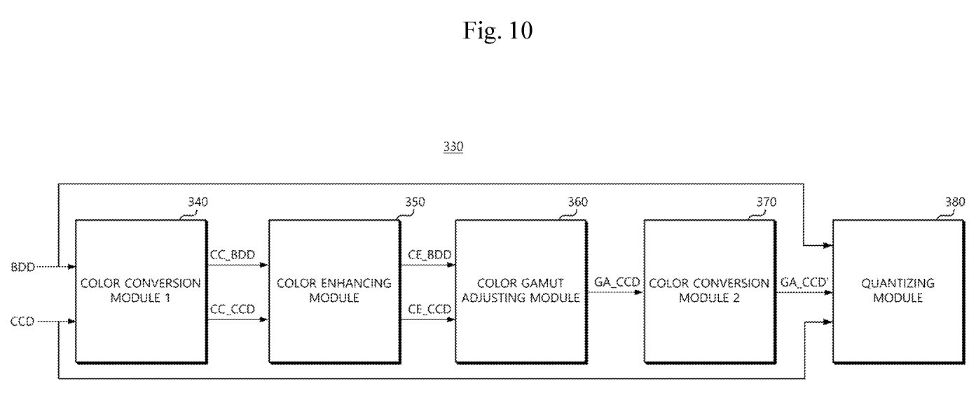

FIG. 10 is a block diagram illustrating the reference table generator circuit 330 of the reference table generating device 20 according to an embodiment of the present disclosure.

The reference table generator circuit 330 may include first and second color conversion modules or circuits 340 and 370, a color enhancing module/circuit 350, a color gamut adjusting module/circuit 360, and a quantizing module/circuit 380.

The reference table generator circuit 330 may receive the bit depth data BDD and the color-corrected data CCD.

The reference table generator circuit 330 may generate color-mapped data GA_CCD in a color space different from the color space in which the bit depth data BDD and the color-corrected data CCD are located. As an example, the bit depth data BDD and the color-corrected data CCD may be located in a first color space, e.g., an RGB color space, and the reference table generator circuit 330 may convert the bit depth data BDD and the color-corrected data CCD into a second color space, e.g., an HSV color space, and then may generate the color-mapped data GA_CCD. In this case, the first color conversion module/circuit 340 may convert the bit depth data BDD and the color-corrected data CCD located in the first color space into the second color space, and the second color conversion module/circuit 370 may convert the color-mapped data GA_CCD into the first color space again.

The reference table generator circuit 330 may generate the color-mapped data GA_CCD in the same color space as the color space in which the bit depth data BDD and the color-corrected data CCD are located. In this case, the reference table generator circuit 330 may not include the first and second color conversion modules 340 and 370.

In an embodiment, the color enhancing module 350 may perform the image processing on bit depth data CC_BDD of which color space is converted and color-corrected data CC_CCD of which color space is converted. As an example, an overall color richness may be improved. According to an embodiment, the reference table generator circuit 330 may not include the color enhancing module 350.

The color gamut adjusting module/circuit 360 may generate the color-mapped data GA_CCD based on color-enhanced bit depth data CE_BDD and color-enhanced and color-corrected data CE_CCD.

As an example, the color gamut adjusting module 360 may generate the color-mapped data GA_CCD by mapping the color-enhanced and color-corrected data CE_CCD located in the second color gamut to the third color gamut in consideration of the color-enhanced bit depth data CE_BDD. The second color gamut may correspond to the second color gamut GM2 of FIG. 5, and the third color gamut may correspond to the third color gamut GM3 of FIG. 5.

The second color conversion module/circuit 370 may convert the color-mapped data GA_CCD back into the first color space and may generate color-mapped data GA_CCD' of the first color space.

The color-mapped data GA_CCD' of the first color space maybe transmitted to the quantizing module/circuit 380, and the quantizing module/circuit 380 may quantize the color-mapped data GA_CCD' of the first color space.

At least one of the bit depth data BDD and the color-corrected data CCD may be transmitted to the quantizing module 380. The quantizing module 380 may quantize at least one of the bit depth data BDD and the color-corrected data CCD. The quantizing module 380 may configure the index of the reference table using at least one of the quantized bit depth data BDD and the quantized color-corrected data CCD.

FIG. 11 is a block diagram illustrating the color gamut adjusting module 360 according to an embodiment of the present disclosure.

The generation of the color-mapped data GA_CCD will be described in detail with reference to FIGS. 11 to 13.

The color gamut adjusting module 360 may include constant axis mapping modules/circuits 361, 362, and 363.

The constant axis mapping modules 361, 362, and 363 may convert any one of color correction component data of the color-enhanced and color-corrected data CE_CCD to generate temporary color mapping component data CA1_CCD, CA2_CCD, and CA3_CCD. In the present embodiments described with reference to FIGS. 10 to 13, the color-enhanced and color-corrected data CE_CCD may be simply referred to as color-corrected data CE_CCD, and the color-enhanced bit depth data CE_BDD may be simply referred to as bit depth data CE_BDD.

An adaptive mapping module/circuit 364 may generate temporary color-mapped data TMP_CCD based on the temporary color mapping component data CA1_CCD, CA2_CCD, and CA3_CCD.

An adaptive mixing module/circuit 365 may generate the color-mapped data GA_CCD using the temporary color-mapped data TMP_CCD and the color-enhanced bit depth data CE_BDD.

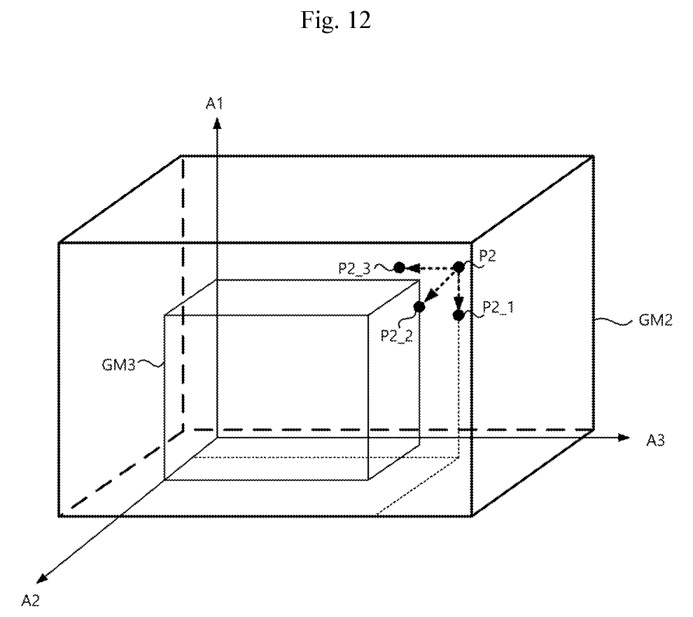

FIG. 12 is a view illustrating an operation of the constant axis mapping modules/circuits 361, 362, and 363 according to an embodiment of the present disclosure.

Each of the constant axis mapping modules 361, 362, and 363 may convert only the channel signal based on any one color axis of the color gamut among the channel signals of the color-corrected data CE_CCD and may keep the channel signals based on other color axes unchanged.

A first constant axis mapping module 361 may keep the channel signals corresponding to a first color axis and a second color axis among the channel signals of the color-corrected data CE_CCD unchanged and may convert the channel signal corresponding to a third color axis.

As an example, referring to FIG. 12, FIG. 12 illustrates a second pixel P2 of the color-corrected data CE_CCD located outside the third color gamut GM3 and inside the second color gamut GM2. The second pixel P2 may correspond to the second pixel P2 of FIG. 5.

Referring to FIG. 12, the first constant axis mapping module/circuit 361 may convert only the channel signal of the second pixel P2 corresponding to the third color axis A3 and may map the second pixel P2 to a pixel P2_3. In the same way, a second constant axis mapping module/circuit 362 may map the second pixel P2 to a pixel P2_1, and a third constant axis mapping module/circuit 363 may map the second pixel P2 to a pixel P2_2. For example, the second pixel P2 may be mapped to the pixels P2_3, P2_1, and P2_2 respectively by the constant axis mapping modules/circuits 361, 362, and 363.

In an embodiment, each of the constant axis mapping modules 361, 362, and 363 may convert a component of each channel signal to allow the second pixel P2 to be closer to the third color gamut GM3. As an example, the first constant axis mapping module 361 may convert the channel signal of the second pixel P2 corresponding to the third color axis A3 to find the pixel P2_3 that is closest to the third color gamut GM3 from the second pixel P2.

The pixels P2_1, P2_2, and P2_3 may correspond to the temporary color mapping component data CA1_CCD, CA2_CCD, and CA3_CCD of FIG. 11.

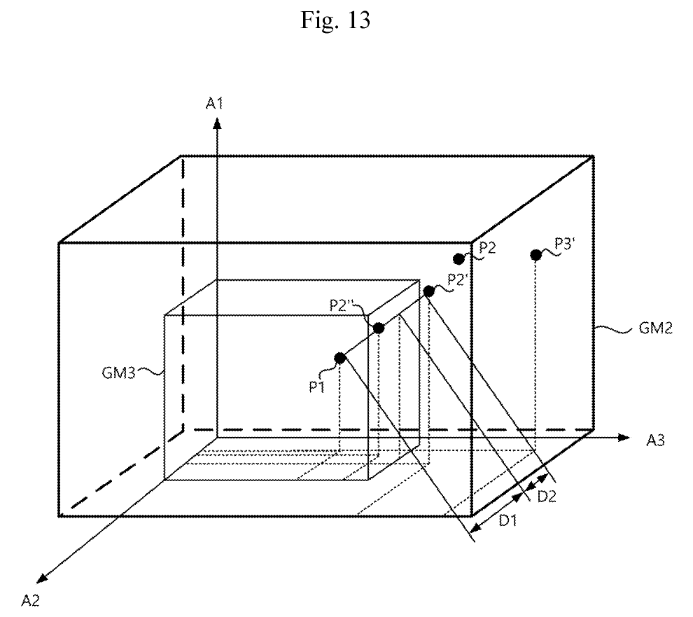

FIG. 13 is a view illustrating an operation of the adaptive mapping module/circuit 364 and the adaptive mixing module/circuit 365 according to an embodiment of the present disclosure.

The adaptive mapping module 364 may generate the temporary color-mapped data TMP_CCD by assigning weights to each of the temporary color mapping component data CA1_CCD, CA2_CCD, and CA3_CCD and interpolating the weighted values. For example, the values corresponding to the temporary color mapping component data CA1_CCD, CA2_CCD, and CA3_CCD may be weighted using the assigned weights and then interpolated to generate the temporary color-mapped data TMP_CCD.

As an example, the adaptive mapping module 364 may generate the pixel P2' obtained by weighting and interpolating the pixels P2_1, P2_2, and P2_3 of FIG. 12, which correspond to the temporary color mapping component data CA1_CCD, CA2_CCD, and CA3_CCD, as the temporary color-mapped data TMP_CCD.

The adaptive mixing module 365 may generate the color-mapped data GA_CCD using the temporary color-mapped data TMP_CCD and the color-enhanced bit depth data CE_BDD.

The adaptive mixing module 365 may generate the color-mapped data GA_CCD based on a distance from each of the temporary color-mapped data TMP_CCD and the color-enhanced bit depth data CE_BDD to a boundary of the first color gamut GM1.

As an example, referring to FIG. 13, the adaptive mixing module 365 may determine a line segment connecting the pixel P2′ of the temporary color-mapped data TMP_CCD and the pixel P1 of the color-enhanced bit depth data CE_BDD. For instance, the line segment may be considered a mathematical line segment in the color space. The adaptive mixing module/circuit 365 may generate the color-mapped data GA_CCD based on distances D1 and D2 between each of the pixel P2′ of the temporary color-mapped data TMP_CCD and the pixel P1 of the color-enhanced bit depth data CE_BDD and a boundary of the third color gamut GM3. For example, the distance D2 may be a distance from pixel P2’ to a boundary of the third color gamut along the line segment connecting pixel P2’ and pixel P1. Similarly, the distance D1 may be the distance from the pixel P1 to the boundary of the third color gamut GM3 along the line segment connecting the pixel P1 and pixel P2’. As an example, the adaptive mixing module 365 may determine the pixel P2″ of the color-mapped data GA_CCD as a value obtained by dividing a sum of a first value, which is obtained by multiplying the distance D1 by the pixel P2′ of the temporary color-mapped data TMP_CCD (e.g., first value = D1 × P2'), and a second value, which is obtained by multiplying the distance D2 by the pixel P1 of the bit depth data CE_BDD (e.g., second value = D2 × P1), by the sum of the distances D1 and D2 (for example, this calculation may be expressed simply as (first value + second value)/(D1+D2).

The adaptive mixing module 365 may determine the color-mapped data GA_CCD by applying more weight or increase weight to be applied to the bit depth data CE_BDD as the distance between the temporary color-mapped data TMP_CCD and the boundary of the third color gamut GM3 increases. As an example, when the pixels P2' and P3' of the temporary color-mapped data TMP_CCD are compared, the bit depth data CE_BDD may exert greater influence on the determination of the color-mapped data GA_CCD when the determination is based on the pixel P3′ of the temporary color-mapped data TMP_CCD, which lies farther from the first color gamut GM1, even when the same bit depth data CE_BDD are used.

The color-corrected data CE_CCD may be first mapped to a region near the first color gamut GM1 by the adaptive mapping module 364, and then, may be secondarily mapped to the first color gamut GM1 by the adaptive mixing module 365 with the bit depth data CE_BDD taken into account. According to an embodiment, the color-corrected data CE_CCD may be first mapped to the third color gamut GM3 by the adaptive mapping module 364, and then, may be secondarily mapped to the third color gamut GM3 by the adaptive mixing module 365 with the bit depth data CE_BDD taken into account.

FIGS. 14 and 15 are views illustrating an operation of the quantizing module 380 according to an embodiment of the present disclosure.

The quantizing module 380 may quantize the color-mapped data GA_CCD. Referring to FIG. 10 again, the quantizing module 380 may quantize the color-mapped data GA_CCD' converted to the third color gamut GM3. In the embodiments described with reference to FIGS. 14 and 15, the color-mapped data GA_CCD' converted to the third color gamut GM3 may be simply referred to as the color-mapped data GA_CCD'.

Referring to FIG. 14, the quantizing module 380 may quantize the color-mapped data GA_CCD' based on each of the color axes of the third color gamut GM3.

FIG. 14 illustrates a pixel PP of the color-mapped data GA_CCD' quantized to a position of an anchor point AP of the quantized color-mapped data.

The pixel PP of the color-mapped data GA_CCD' may be quantized to the anchor point AP of the quantized color-mapped data according to sampling intervals based on a first color axis B1, a second color axis B2, and a third color axis B3.

As an example, the quantizing module 380 may quantize the pixel PP in a space BLi generated by the sampling intervals based on the first color axis B1, the second color axis B2, and the third color axis B3 to one of vertices of the space BLi. FIG. 14 illustrates the pixel PP in the space BLi, which is mapped to the anchor point AP that is a vertex with the smallest value among the vertices of the space BLi. A point in the space BLi to which the pixel in the space BLi is mapped may be referred to as an anchor point in the present disclosure. The pixel PP and the anchor point AP in the space BLi may be spaced apart from each other by distances DIST1, DIST2, and DIST3 in directions of the first color axis B1, the second color axis B2, and the third color axis B3, respectively.

Referring to FIG. 15, the quantizing module 380 may divide the third color gamut GM3 where the color-mapped data GA_CCD' is located with non-uniform sampling intervals and may quantize the color-mapped data GA_CCD' based on the non-uniform sampling intervals.

As an example, referring to FIG. 15, the quantizing module 380 may divide at least a portion of the first color gamut GM1 with different sampling intervals SHIFT_p, SHIFT_q, and SHIFT_r along the third color axis B3 and may quantize the color-mapped data GA_CCD'. According to an embodiment, at least a portion of the non-uniform sampling intervals may vary in powers of two. As an example, some sampling intervals SHIFT_p, SHIFT_q, and SHIFT_r among the sampling intervals may increase in powers of two along the third color axis B3.

In an embodiment, the sampling interval of each of the color axes B1, B2, and B3 may be different from each other or may be the same as each other.

In an embodiment, the quantizing module 380 may store, together with the reference table LUT, information about the sampling interval of the third color gamut GM3.

In an embodiment, the quantizing module 380 may sequentially increase the sampling interval in powers of two, such as 1, 2, 4, 8, 16, 32, and so on. In this case, the electronic device 10 may determine the sampling interval based on the position of the anchor point.

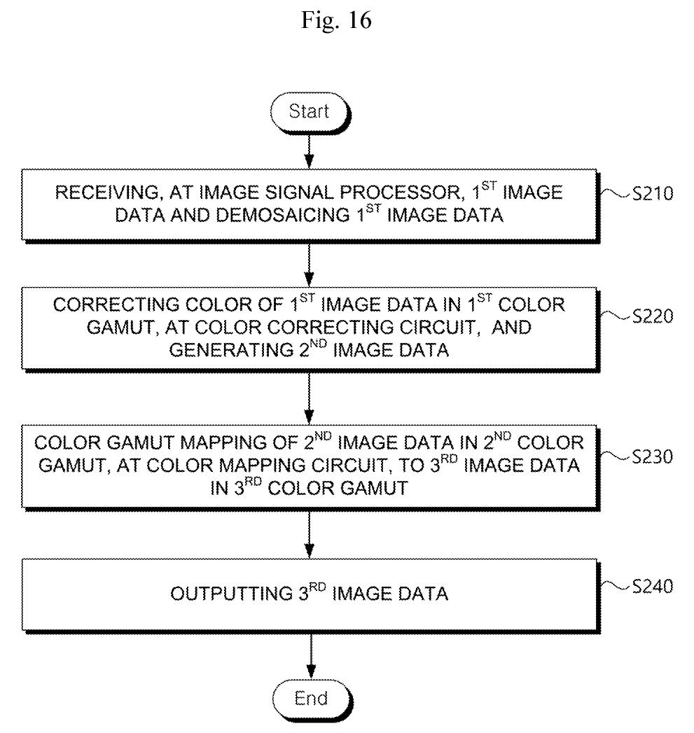

FIG. 16 is a flowchart illustrating a method of operating the electronic device that performs the color gamut mapping of image data according to an embodiment of the present disclosure. An operation method to perform the color gamut mapping of FIG. 16 may be carried out by the electronic device 10 of FIGS. 1 and 2. As an example, an operation method to perform the color gamut mapping of FIG. 16 may be carried out by the image signal processor 120 of the electronic device 10 of FIGS. 1 and 2.

The electronic device 10 may map the image data located in one color gamut to another color gamut using the reference table LUT described with reference to FIGS. 5 to 15.

The operation method to perform the color gamut mapping of the image signal processor 120 will be described with reference to FIGS. 1 and 16.

Referring to FIG. 16, in operation S210, the image signal processor 120 may receive the first image data located in the first color gamut. As an example, the image signal processor 120 may receive the raw image data IDT_RAW from the camera module 200. The raw image data IDT_RAW may be located in the first color gamut. The image signal processor 120 may demosaic the first image data.

In operation S220, the color correcting circuit 160 of the image signal processor 120 may color-correct the demosaiced first image data using a color correcting circuit to generate the second image data located in the second color gamut. As an example, the image signal processor 120 may apply the color correction matrix to the raw image data IDT_RAW of FIG. 1 to generate the second image data located in the second color gamut. The color correction matrix may be generated based on characteristic information of the camera module 200 of FIG. 1. The color correction matrix may be generated by the reference table generating device 20 of FIG. 2 or a separate device. The second color gamut may be larger than the first color gamut.

In operation S230, the image signal processor 120 may map the second image data to the third color gamut based on the reference table to convert the second image data to third image data. The reference table may correspond to the reference table 141 of FIG. 1 or the reference table LUT of FIG. 5. The reference table may be generated by the methods of FIGS. 5 to 13 using the reference table generating device 20 of FIG. 2.

In operation S240, the image signal processor 120 may output the third image data located in the third color gamut. The output third image data may be stored in the storage device of the electronic device 10.

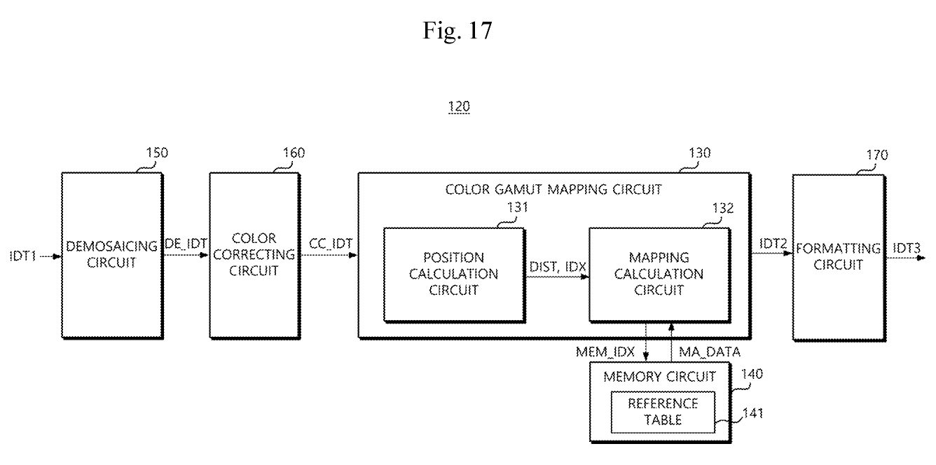

FIG. 17 is a block diagram illustrating the image signal processor of the electronic device 10 of FIG. 1 according to an embodiment of the present disclosure. The image signal processor 120 of FIG. 17 may correspond to the image signal processor 120 of FIGS. 1 and 2. The configuration of the image signal processor 120 will be described with reference to FIG. 17. Detailed explanations that are identical or similar to those described with reference to FIGS. 1 to 16 will be omitted.

The image signal processor 120 may include a demosaicing circuit 150, a color correcting circuit 160, the color gamut mapping circuit 130, the memory circuit 140, and a formatting circuit 170.

The demosaicing circuit 150 may demosaic first image data IDT1 and may generate the demosaiced first image data DE_IDT. The demosaiced first image data DE_IDT may include a plurality of channel image data. As an example, the demosaiced first image data DE_IDT may include at least one channel image data. In a case where the first image data IDT1 is based on a Bayer pattern, the demosaicing circuit 150 may demosaic the first image data IDT1 to generate red channel image data, green channel image data, and blue channel image data.

The first image data IDT1 and the demosaiced first image data DE_IDT may be located in the first color gamut.

The color correcting circuit 160 may apply the color correction matrix to the demosaiced first image data DE_IDT to generate color correction image data CC_IDT. As an example, the demosaiced first image data DE_IDT may include three channel image data, and the color correcting circuit 160 may apply a 3×3 color correction matrix to the channel image data of the demosaiced first image data DE_IDT to generate the color correction image data CC_IDT.

Some pixels of the color correction image data CC_IDT may be located in the second color gamut. The second color gamut may be a wider color gamut than the first color gamut. In an embodiment, the second color gamut may include the first color gamut.

In an embodiment, one of elements of the color correction matrix may have a negative number or negative value. For example, in this case, the second color gamut may include a region where at least a portion of the channel signals of the image data has a negative value with respect to the color axes of the color space. As an example, a portion of the channel image data of some pixels of the color correction image data CC_IDT may have the negative value.

The color gamut mapping circuit 130 may map the color correction image data CC_IDT located in the second color gamut to the third color gamut based on the reference table 141 and may output second image data IDT2. The reference table 141 may be stored in the memory circuit 140. According to an embodiment, the reference table 141 may be stored in a memory device outside the image signal processor 120. As an example, the reference table 141 may be stored in the memory device 300 of FIG. 1.

The reference table 141 may include a conversion relationship between first pixel data of the first color gamut and second pixel data of the second color gamut.

The color gamut mapping circuit 130 may include a position calculation circuit 131 and a mapping calculation circuit 132.

The position calculation circuit 131 may receive the color correction image data CC_IDT located in the first color gamut and may calculate initial mapping data IDX corresponding to the color correction image data CC_IDT in the reference table 141. Further, the position calculation circuit 131 may calculate distance information DIST representing a difference between the color correction image data CC_IDT and the initial mapping data IDX. For example, the position calculation circuit may determine initial mapping data (IDX) that indicate indices corresponding to the color correction image data (CC_IDT) in the reference table 141 such as reference tables of FIG. 5 and FIG. 9. The reference table may be generated by embodiments of FIG. 14 and FIG. 15. The position calculation circuit 131 may calculate distance between the color correction image data CC_IDT and the initial mapping data IDX.

The mapping calculation circuit 132 may calculate the second image data IDT2 based on the initial mapping data IDX and the distance information DIST.

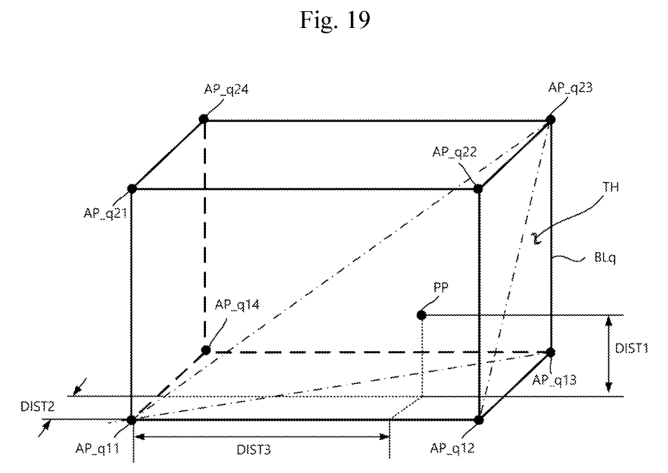

As an example, the mapping calculation circuit 132 may calculate memory index MEM_IDX based on the initial mapping data IDX. The memory index MEM_IDX may indicate peripheral mapping data MA_DATA stored in the reference table 141. The mapping calculation circuit 132 may calculate the second image data IDT2 based on the peripheral mapping data MA_DATA and the distance information DIST. As an example, the memory index MEM_IDX may refer to an memory address or memory index value used to locate the peripheral mapping data MA_DATA in memory device. For example, the peripheral mapping data MA_DATA may be the anchor points constituting a tetrahedron TH to which the pixel PP of the second image data IDT2 belongs as FIG. 19.

The formatting circuit 170 may format the second image data IDT2 located in the first color gamut to comply with the image format and may output formatted third image data IDT3. The formatted third image data IDT3 may be stored in the storage device or displayed through a display device. According to an embodiment, the formatted third image data IDT3 may be displayed through the display device after being mapped to a color gamut of the display device.

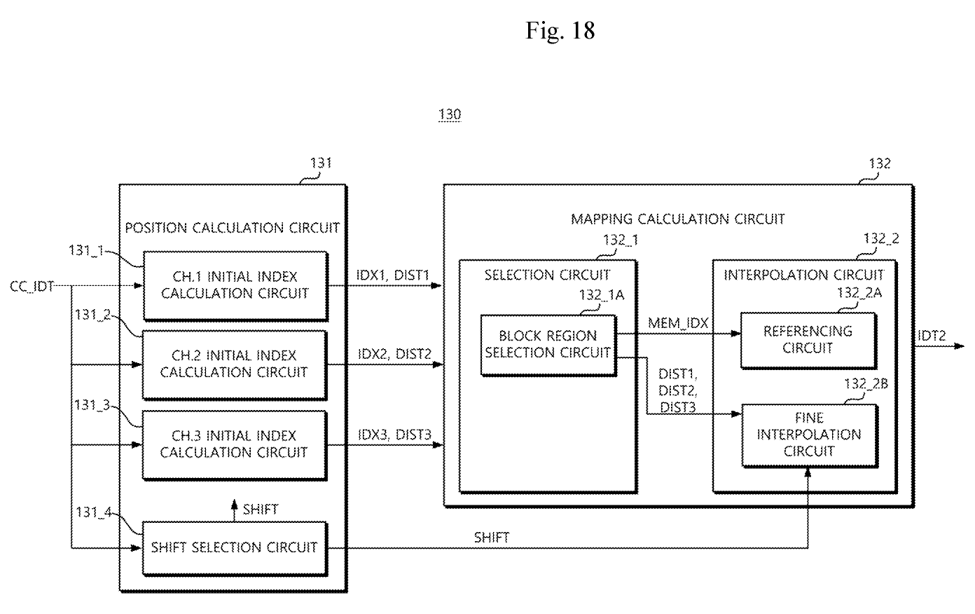

FIG. 18 is a block diagram illustrating the color gamut mapping circuit 130 of the image signal processor 120 according to an embodiment of the present disclosure. The color gamut mapping circuit 130 of FIG. 18 may correspond to the color gamut mapping circuit 130 of FIG. 17. Detailed explanations that are identical or similar to those described with reference to FIGS. 1 to 17 will be omitted.

Referring to FIG. 18, the position calculation circuit 131 may include a plurality of channel initial index calculation circuits 131_1, 131_2, and 131_3 and a shift selection circuit 131_4.

The channel initial index calculation circuits 131_1, 131_2, and 131_3 may respectively calculate initial indices IDX1, IDX2, and IDX3 and distance information DIST1, DIST2, and DIST3 for each channel of the color correction image data CC_IDT. The initial index may be referred to as initial mapping data. Each of the channel initial index calculation circuits 131_1, 131_2, and 131_3 may receive a sampling interval SHIFT or sampling interval SHIFT value from the shift selection circuit 131_4. The channel initial index calculation circuits 131_1, 131_2, and 131_3 may calculate the initial indices IDX1, IDX2, and IDX3, respectively, based on the sampling interval SHIFT.

According to an embodiment, the sampling intervals may be different for each channel. The embodiment of FIG. 18 will be described on the assumption that the sampling intervals of the respective channels are the same.

A shift selection circuit 131_4 may determine the sampling interval corresponding to the color correction image data CC_IDT.

Each of the channel initial index calculation circuits 131_1, 131_2, and 131_3 may receive color correction channel image data of each pixel of the color correction image data CC_IDT. As an example, a first channel initial index calculation circuit 131_1 may receive first color correction channel image data of each pixel of the color correction image data CC_IDT.

The first channel initial index calculation circuit 131_1 may divide a number of upper bit signals among the bit signals of the first color correction channel image data based on the sampling interval SHIFT and may output the divided upper bit signals as a first initial index IDX1. As an example, the first channel initial index calculation circuit 131_1 may divide the upper bit signals corresponding to the sampling interval SHIFT. For example, the sampling interval SHIFT may provide a value in which to divide or use to shift the number of upper of bits.

The first channel initial index calculation circuit 131_1 may divide remaining bit signals of the first color correction channel image data except the bit signals used as the first initial index IDX1 and may output the divided bit signals as first distance information DIST1. Depending on context, dividing or division may be bitwise division, e.g., in powers of2.

Similar to the first channel initial index calculation circuit 131_1, a second channel initial index calculation circuit 131_2 and a third channel initial index calculation circuit 131_3 may output the initial indices IDX2 and IDX3, respectively, and may output the distance information DIST2 and DIST3, respectively.

The shift selection circuit 131_4 may determine the sampling interval SHIFT based on the sampling intervals described with reference to FIG. 15.

According to an embodiment, the shift selection circuit 131_4 may store in advance information of the sampling intervals described with reference to FIG. 15.

As an example, when the uniform sampling interval of 32 is used to quantize the pixel of the color correction channel image data, the shift selection circuit 131_4 may transmit the sampling interval of 32 to the channel initial index calculation circuits 131_1, 131_2, and 131_3. Each of the channel initial index calculation circuits 131_1, 131_2, and 131_3 may calculate the initial index and the distance information based on the sampling interval of 32.

As an example, when the pixel of the color correction channel image data is quantized using the non-uniform sampling interval, the shift selection circuit 131_4 may store in advance information on the non-uniform sampling intervals and may transmit the sampling interval corresponding to the pixel of the image data to the channel initial index calculation circuits 131_1, 131_2, and 131_3. Each of the channel initial index calculation circuits 131_1, 131_2, and 131_3 may calculate the initial index and the distance information based on the sampling interval.

The mapping calculation circuit 132 may include a selection circuit 132_1 and an interpolation circuit 132_2.

A block region selection circuit 132_1A of the selection circuit 132_1 may select peripheral mapping data near, e.g., surrounding, the second image data IDT2 to which the color correction image data CC_IDT is mapped based on the initial indices IDX1, IDX2, and IDX3 and the distance information DIST1, DIST2, and DIST3.

The interpolation circuit 132_2 may interpolate the peripheral mapping data near or surrounding the second image data IDT2 to generate the second image data IDT.

FIG. 19 is a view illustrating an operation of the block region selection circuit 132_1A according to an embodiment of the present disclosure.

Referring to FIG. 19, the block region selection circuit 132_1A may determine a position of an anchor point AP_q11 where the second image data IDT2 is quantized based on the initial indices IDX1, IDX2, and IDX3. As an example, the pixel corresponding to the initial indices IDX1, IDX2, and IDX3 may be required to be mapped to the pixel PP of the second image data IDT2, and the pixel PP of the second image data IDT2 may be quantized to the anchor point AP_q11 and may be stored in the reference table 141.

In a case where a block BLq, which is defined by the anchor point AP_q11 and its peripheral anchor points AP_q12, AP_q13, AP_q14, AP_q21, AP_q22, AP_q23, and AP_q24, is divided into a plurality of tetrahedrons, the block region selection circuit 132_1A may determine which tetrahedron the pixel PP of the second image data IDT2 belongs to. The block region selection circuit 132_1A may determine which tetrahedron the pixel PP of the second image data IDT2 belongs to using the distance information DIST1, DIST2, and DIST3.

The block region selection circuit 132_1A may divide the block BLq into the tetrahedrons that obligatorily include the anchor point AP_q11 and may determine which tetrahedron among the divided tetrahedrons the pixel PP of the second image data IDT2 belongs to.

As an example, the block BLq of FIG. 19 may be divided into a first tetrahedron having anchor points AP_q11, AP_q12, AP_q13, and AP_q23 as its vertices, a second tetrahedron having anchor points AP_q11, AP_q12, AP_q22, and AP_q23 as its vertices, a third tetrahedron having anchor points AP_q11, AP_q21, AP_q22, and AP_q23 as its vertices, a fourth tetrahedron having anchor points AP_q11, AP_q13, AP_q14, and AP_q23 as its vertices, a fifth tetrahedron having anchor points AP_q11, AP_q14, AP_q23, and AP_q24 as its vertices, and a sixth tetrahedron having anchor points AP_q11, AP_q21, AP_q23, and AP_q24 as its vertices. FIG. 19 illustrates an example in which the pixel PP of the second image data IDT2 belongs to the first tetrahedron.

As an example, the block region selection circuit 132_1A may compare sizes of the distance information DIST1, DIST2, and DIST3 to determine which tetrahedron among the tetrahedrons constituting the block BLq the pixel PP of the second image data IDT2 belongs to.

In an embodiment, the block region selection circuit 132_1A may determine the anchor points constituting a tetrahedron TH to which the pixel PP of the second image data IDT2 belongs as the peripheral mapping data and may output the memory index MEM_IDX of the peripheral mapping data in a memory device which the peripheral mapping data are stored in. For example, the memory index MEM_IDX may be a memory address of the peripheral mapping data in the memory device. For example, the block region selection circuit 132_1A may output indices corresponding to peripheral mapping data (e.g., anchor points) defining a tetrahedral region associated with the pixel, the indices representing stored positions of the selected anchor points within the memory device. The block region selection circuit 132_1A may output the distance information DIST1, DIST2, and DIST3.

As an example, FIG. 19 illustrates that the pixel PP of the second image data IDT2 belongs to the first tetrahedron TH defined by the anchor points AP_q11, AP_q12, AP_q13, and AP_q23. The block region selection circuit 132_1A may determine that the pixel PP of the second image data IDT2 belongs to the first tetrahedron TH defined by the anchor points AP_q11, AP_q12, AP_q13, and AP_q23. The block region selection circuit 132_1A may determine the anchor points AP_q11, AP_q12, AP_q13, and AP_q23 to the peripheral mapping data and may output the memory index MEM_IDX of the peripheral mapping data AP_q11, AP_q12, AP_q13, AP_q23. The block region selection circuit 132_1A may output the distance information DIST1, DIST2, and DIST3 of the pixel PP of the second image data IDT2. The distance information DIST1, DIST2, and DIST3 may be distances along each of the axes from the anchor point AP_q11.

FIG. 19 illustrates the method of determining the position of the pixel of the second image data IDT to which each pixel of the color correction image data CC_IDT is mapped using the anchor points of the tetrahedron to which the second image data IDT2 belong among the tetrahedrons constituting the block BLq. However, the block region selection circuit 132_1A may determine the position of the pixel in the second image data IDT to which each pixel of the color correction image data CC_IDT is mapped by using all anchor points constituting the block BLq. In this case, the interpolation circuit 132_2 may interpolate positions of the pixels corresponding to all anchor points constituting the block BLq to determine the position of the pixel of the second image data IDT to which each pixel of the color correction image data CC_IDT is mapped.

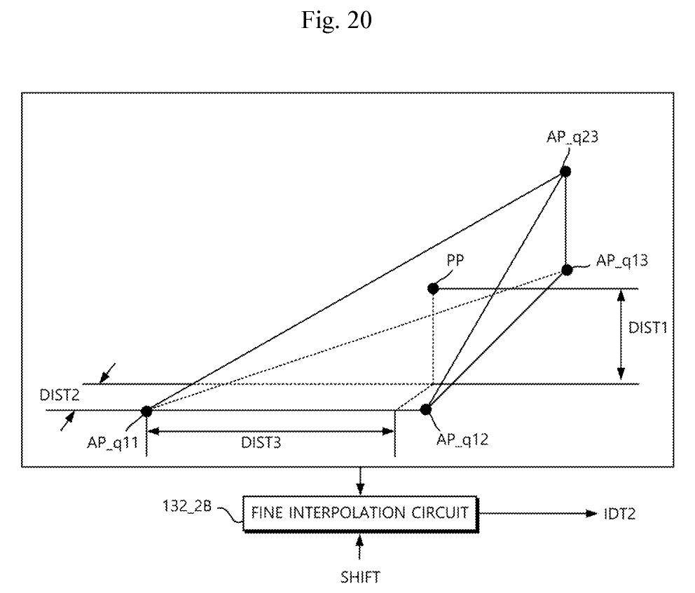

FIG. 20 is a view illustrating an operation of the interpolation circuit 132_2 according to an embodiment of the present disclosure.

A referencing circuit 132_2A of the interpolation circuit 132_2 may refer, in the reference table 141, to data indexed by the anchor points AP_q11, AP_q12, AP_q13, and AP_q23 that constitute the tetrahedron TH to which the second image data IDT2 belong, based on the memory index MEM_IDX. The data indexed by the anchor points AP_q11, AP_q12, AP_q13, and AP_q23 may represent the positions of the pixels corresponding to each of the anchor points AP_q11, AP_q12, AP_q13, and AP_q23 in the third color gamut GM3

A fine interpolation circuit 132_2B of the interpolation circuit 132_2 may interpolate the positions of the pixels corresponding to each of the anchor points AP_q11, AP_q12, AP_q13, and AP_q23 in the third color gamut GM3 and may determine the position of the pixel PP of the second image data IDT to which each pixel of the color correction image data CC_IDT is mapped.

The fine interpolation circuit 132_2B may interpolate the positions of the pixels corresponding to each of the anchor points AP_q11, AP_q12, AP_q13, and AP_q23 using the distance information DIST1, DIST2, and DIST3 and the sampling interval SHIFT of the block BLq.

The sampling interval SHIFT may be a value referring to or indicating a distance between the anchor points along the color axes. In FIG. 20, the description is based on the assumption that the sampling intervals along the color axes are identical. Differently, the sampling intervals along the color axes may be different from one another.

The fine interpolation circuit 132_2B may interpolate the positions of the pixels corresponding to each of the anchor points AP_q11, AP_q12, AP_q13, and AP_q23 and may determine the position of the pixel of the second image data IDT to which each pixel of the color correction image data CC_IDT is mapped.

The mapping calculation circuit 132 may output the second image data IDT as final color gamut mapping data without clipping the second image data IDT.

By the operation of the image signal processor 120 described with reference to FIGS. 16 to 20, the channel image data of the color correction image data CC_IDT located in the second color gamut may be output, without being clipped, as the second image data IDT2 that are mapped to the third color gamut.

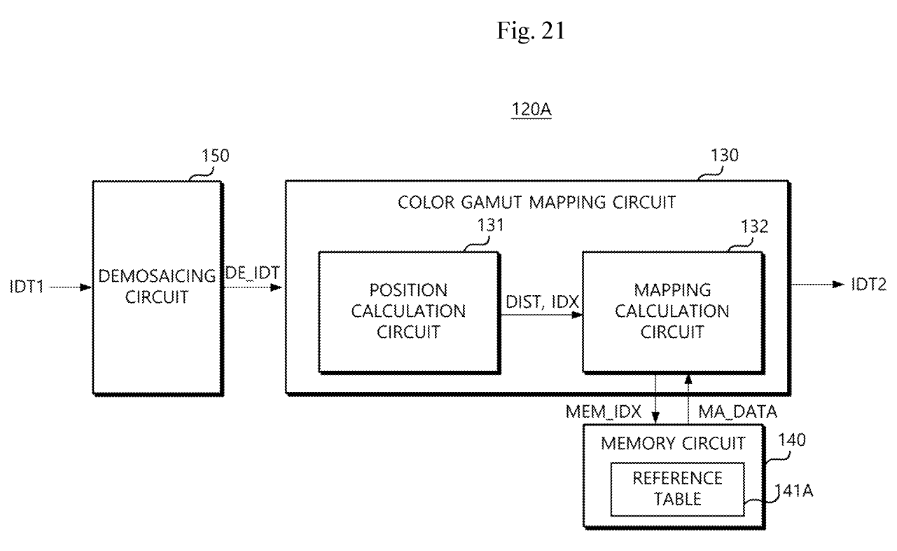

FIG. 21 is a block diagram illustrating an image signal processor 120A according to an embodiment of the present disclosure. Hereinafter, the description will be focused on different features from the image signal processor 120 described with reference to FIG. 17.

Referring to FIG. 21, different from the image signal processor 120 of FIG. 17, the image signal processor 120A may not include the color correcting circuit 160.

A color gamut mapping circuit 130 of the image signal processor 120A may receive first image data IDT1 of a first color gamut and may demosaic the first image data IDT1. The color gamut mapping circuit 130 may simultaneously perform color correction and color mapping on the demosaiced first image data DE_IDT.

In this case, different from the reference table 141 of FIG. 17, a reference table 141A of FIG. 21 may be a reference table whose indices are configured on the basis of the bit depth data BDD of FIG. 5.

Accordingly, different from the reference table 141 of FIG. 17, the reference table 141A may store color correction relationships between image data respectively located in color gamuts that are representable with the same number of bit signals.

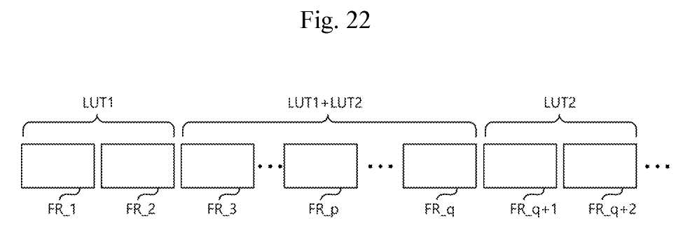

FIG. 22 is a view illustrating a color gamut mapping method for a video of an electronic device according to an embodiment of the present disclosure. The color gamut mapping method for the video of FIG. 22 may be performed by the electronic device 10 of FIGS. 1 and 2.

The electronic device 10 may store a plurality of reference tables LUT1 and LUT2.

The electronic device 10 may perform color correction of a subset FR_1 and FR_2 of frames of the video and then may perform the color gamut mapping of the subset FR_1 and FR_2 using a first reference table LUT1. For another subset FR_3 to FR_q of frames, a result obtained by performing the color correction and then performing the color gamut mapping using the first reference table LUT1 and a result obtained by performing the color correction and then performing the color gamut mapping using a second reference table LUT2 may be interpolated. Then, for another subset FR_q+1 and FR_q+2 of the frames, the color correction may be performed and then the color gamut mapping may be performed using the second reference table LUT2.

Accordingly, for the video, the electronic device 10 may perform the color gamut mapping using different reference tables for different frames. The electronic device 10 may perform the color gamut mapping on some frames of a segment using multiple reference tables to ensure transitions between different frames remain seamless.

While the present disclosure has been described with reference to embodiments thereof, it will be apparent to those of ordinary skill in the art that various changes and modifications may be made thereto without departing from the spirit and scope of the present disclosure.

What is claimed is:

1. A method of mapping a color gamut, comprising:
obtaining, by at least one processor, bit depth data corresponding to bit data that is representable in a three-dimensional first color gamut;
generating, by the at least one processor, color-corrected data comprising correcting color of the bit depth data;
generating, by the at least one processor, color-mapped data of a three-dimensional second color gamut based on the bit depth data and the color-corrected data; and
quantizing, by the at least one processor, the color-mapped data; and
generating, by the at least one processor, a three-dimensional reference table based on the quantized color-mapped data.

2. The method of claim 1, wherein generating the color-corrected data comprises performing, by the at least one processor, a color correction on the bit depth data based on characteristic data of an image sensor.

3. The method of claim 1, further comprising:
quantizing, by the at least one processor, the color-corrected data,
wherein generating the reference table further comprises:
generating, by the at least one processor, an index of the reference table based on the quantized color-corrected data, and
generating, by the at least one processor, data of the reference table based on the quantized color-mapped data.

4. The method of claim 1, further comprising:
quantizing, by the at least one processor, the bit depth data;
wherein generating the reference table further comprises:
configuring an index of the reference table based on the quantized bit depth data, and
configuring data of the reference table based on the quantized color-mapped data.

5. The method of claim 1, further comprising:
generating, by the at least one processor, pre-color-mapped data by converting at least one of color correction component data of the color-corrected data; and
generating, by the at one processor, the color-mapped data based on the pre-color-mapped data and the bit depth data,
wherein the color correction component data are components corresponding to each of axes of the second color gamut of the color-corrected data.

6. The method of claim 5, further comprising generating, by the at least one processor, the color-mapped data based on a distance between a boundary of the second color gamut and each of the pre-color-mapped data and the bit depth data.

7. The method of claim 6, wherein the color-mapped data are generated by applying more weight to the bit depth data as the distance between the boundary of the second color gamut and the pre-color-mapped data increases.

8. A system-on-chip comprising:
;
an image signal processor configured to receive a raw image data from an image sensor and to process the raw image data; and
a memory device configured to store a reference table comprising a conversion relationship between first pixel data of a first color gamut and second pixel data of a second color gamut,
wherein the image signal processor comprises a color gamut mapping circuit configured to map first image data located in the first color gamut to the second color gamut based on the reference table, and configured to output second image data located in the second color gamut based on the mapping of the first image data.

9. The system-on-chip of claim 8, wherein the color gamut mapping circuit comprises:
a position calculation circuit configured to receive the first image data comprising values for one or more pixels which are located in the first color gamut, and to calculate initial mapping data, the initial mapping data indicating indices in the reference table corresponding to the first image data, and to calculate distance information indicating a difference between the first image data and the initial mapping data; and
a mapping calculation circuit configured to generate the second image data based on the initial mapping data and the distance information.

10. The system-on-chip of claim 9, wherein the mapping calculation circuit comprises:
a selection circuit configured to select peripheral mapping data surrounding the second image data based on the initial mapping data and the distance information; and
an interpolation circuit configured to generate the second image data by interpolating image data of the second color gamut, which respectively correspond to the peripheral mapping data.

11. The system-on-chip of claim 8, wherein the image signal processor is configured to output unclipped portions of the second image data as final color gamut mapping data.

12. The system-on-chip of claim 11, wherein at least one pixel of the first image data comprises image channel data having negative values.

13. The system-on-chip of claim 8, wherein the image signal processor further comprises:
a demosaicing circuit configured to demosaic the raw image data; and
a color correcting circuit configured to perform a color correction on the demosaiced raw image data, and configured to output the demosaiced raw image data as the first image data.

14. The system-on-chip of claim 13, wherein the color correcting circuit is further configured to generate image channel data of the first image data by applying a color correction matrix to image channel data of the demosaiced raw image data, and
wherein at least one of elements of the color correction matrix comprises a negative value.

15. The system-on-chip of claim 8, wherein each level of data of the reference table corresponds non-uniformly to the second color gamut.

16. The system-on-chip of claim 8, wherein the first color gamut is the same color gamut as the second color gamut, or the first color gamut is a wider color gamut than the second color gamut.

17. A method of operating a system-on-chip, comprising:
receiving, by an image signal processor, first image data located in a first color gamut;
demosaicing, by the image signal processor, the first image data;
generating, , by a color correcting circuit of the image signal processor, second image data located in a second color gamut by correcting color of the demosaiced first image data;
converting , by a color mapping circuit of the image signal processor, the second image data to third image data by mapping the second image data to the first color gamut based on a reference table; and
outputting, by the image signal processor, the third image data located in the first color gamut.

18. The method of claim 17, wherein pixel data of the first image data comprises image channel data having negative values.

19. The method of claim 17, wherein the first color gamut is the same color gamut as the second color gamut, or the first color gamut is a wider color gamut than the second color gamut.

20. The method of claim 17, wherein indices of the reference table correspond to the second color gamut, and data entries of the reference table correspond to the first color gamut.
